(19) United States
(12) Patent Application Publication
(10) Pub. No.: US 2024/0061085 A1
(43) Pub. Date: Feb. 22, 2024

(54) Solid-state scanning flash lidar by diffractive field-of-view steering with digital micromirror device

(71) Applicant: Arizona Board of Regents on Behalf of the University of Arizona, Tucson, AZ (US)

(72) Inventors: Yuzuru TAKASHIMA, Tucson, AZ (US); Jeff Ching-Wen CHAN, Tucson, AZ (US); Xianyue DENG, Tucson, AZ (US)

(21) Appl. No.: 18/235,617

(22) Filed: Aug. 18, 2023

Related U.S. Application Data
(60) Provisional application No. 63/399,594, filed on Aug. 19, 2022.

(51) Int. Cl. G01S 7/481; G01S 7/4865

(52) U.S. Cl. CPC G01S 7/4817; G01S 7/4814; G01S 7/4816; G01S 7/4865

(57) ABSTRACT

A LIDAR system includes a laser source configured to generate laser light pulses, a first DMD, a second DMD and a two-dimensional (2D) sensor array. The first DMD is configured to receive the laser light pulses and diffractively steer the light pulses to sequentially illuminate different sub-regions within the extended region. The second DMD is configured to receive reflected light pulses from the different sub-regions in a sequential manner as each of the different sub-regions is illuminated by the light pulses. The 2D sensor array configured to receive reflected light pulses from the second DMD and form an image of the different sub-regions as the reflected light pulses from each of the different sub-regions is sequentially received from the second DMD.

### CROSS REFERENCE TO RELATED APPLICATION

This application claims the benefit of U.S. Provisional Application Ser. No. 63/399,594, filed Aug. 19, 2022, the contents of which are incorporated herein by reference.

### BACKGROUND

Lidar has been widely used in autonomous driving vehicles and Advanced Driver Assistant Systems (ADASs). A lidar system with a wide field of view (FOV), high angular resolution (<0.1 degrees), and fast scanning rate (>30 fps), large detection range are needed for automotive object detection in a 3-dimensional space. For ADAS, a long-range lidar system detects returning photons from objects located at several hundreds of meters with a limited FOV. In contrast, short-range lidar systems detect objects approaching from the sides of the vehicle with a large FOV, i.e., 90 degrees in the horizontal direction. Such an application specific 3D sensing volume defines lidar optical architecture, which is predominantly governed by radiometry of the lidar system. For example, a long range lidar system obtaining enough returning photons reflected from objects plays a critical role because the number of retuning photons scales with

$${( \frac{1}{R} )}^{2}$$

where R is the distance of the object away from the detector. To recover the fall off signal from a distance object, a large aperture for the receiver is needed. Therefore, trade-offs arise in the selection of scanning modalities along with the selection of sensors, such as a single detector for a point-and-shoot lidar system, and 1- or 2-dimensional array sensor for flash scanning lidar systems.

Recently, a solid-state silicon photomultiplier (SiPM), which is also referred to as a Multi-Pixel Photon Counter (MPPC), has been introduced for infrared lidar applications. An MPPC pixel with a microcell size of 100 μm consists of a sub-array of an Avalanche Photo Diode (APD) operating in a Geiger mode with a quenching resistor. For lidar applications, the 2-dimensional sensor array of the MPPC provides about 10% of the photon detection efficiency at 905 nm, which is suitable for lidar sensors. However, the number of pixel counts of the 2D MPPC sensor array is rather modest at this point, around 1-2 k pixels. With a pixel pitch of 25 μm, the device area is on the order of 1-2 mm, which is relatively small compared to a conventional complementary metal-oxide semiconductor (CMOS) image sensor. If a 2D MPPC array image sensor is used for a flash lidar system with 0.1 degree resolution, the total FOV is limited to 1-2 degrees with a 1-2 k pixel count.

To overcome such a limited FOV while accommodating a large aperture, mechanical scanning modalities such as scanning mirrors and Risley prisms have been employed. However, these scanning mechanisms themselves limit the scan speed. Micro Electro Mechanical System (MEMS) resonant mirrors can support a large scanning angle and high scanning speed at the expense of the limited aperture size, which typically are on the order of mms. The challenge is to simultaneously satisfy the requirements of a large scanning angle, a large beam area and a fast scan rate in a reliable manner.

Another class of MEMS devices, the Texas Instrument Digital Micromirror Device (DMD), is uniquely positioned because of its large aperture area (>100 mm²) and fast frame rate (>40 kHz). Over the past several decades, DMDs have been used as display panels for projection displays. The DMD employs an array of electrostatically actuated mirrors to spatially modulate light. The micromirror element tilts along its rotation axis in +12° between the on-state and off-state. The on-state micromirrors redirect the light to the pupil of a projection lens, while the off-state micromirrors redirect the light outside of the pupil. In this way, illuminating light is spatially modulated in a pixelated manner to form an image at projection screen. The frame rate of a DMD exceeds several tens of kHz, enabling a pulse width modulation of light for a full colored RGB display by synchronizing the pattern to a sequential LED RGB illumination source.

Recently, as described in U.S. Pat. No. 11,635,614 and B. Smith, B. Hellman, A. Gin, A. Espinoza, and Y. Takashima, “Single chip lidar with discrete beam steering by digital micromirror device,” Opt. Express 25(13), 14732 (2017), a new illumination scheme employing nano second laser pulses with a DMD was proposed to steer the beam into one out of multiple directions with high efficiency. In the beam steering process, the DMD is first triggered to actuate all the micromirrors from the off-state to the on-state. While the mirrors are in motion, a nanosecond pulse illuminates the micromirrors. Due to the three orders of magnitude difference in the time scale between the transitional period of the DMD from the off- to the on-state (several μs) and ns pulse, the dynamic movement of the micromirrors between the off-state and on-state is effectively “frozen” so that the transitional states of micromirrors satisfies the blazed grating condition. In this way high efficiency beam and image steering is achieved. The ns pulse illumination has an affinity to Time of Flight (ToF) lidar, though the number of scanning points is still limited with multiple laser sources. The limited number of scanning points was addressed by combining two kinds of MEMS devices, a MEMS resonant mirror and a DMD in E. Kang, H. Choi, B. Hellman, J. Rodriguez, B. Smith, X. Deng, P. Liu, T. Lee, E. Evans, Y. Hong, J. Guan, C. Luo, and Y. Takashima, “All-MEMS Lidar Using Hybrid Optical Architecture with Digital Micromirror Devices and a 2D-MEMS Mirror,” Micromachines 13(9), 1444 (2022). Fine steering within a narrow FOV (5 degrees) is employed by a MEMS resonant mirror while a DMD steers the FOV of the MEMS resonant mirror over the FOV. For a receiver a single APD detector is used and the receiver DMD covers the 35 degree FOV.

The lidar system described in E. Kang, H. Choi, B. Hellman, J. Rodriguez, B. Smith, X. Deng, P. Liu, T. Lee, E. Evans, Y. Hong, J. Guan, C. Luo, and Y. Takashima, “All-MEMS Lidar Using Hybrid Optical Architecture with Digital Micromirror Devices and a 2D-MEMS Mirror,” Micromachines 13(9), 1444 (2022) employs a MEMS-resonant mirror and a DMD forms a lidar image by point-by-point steering and detection by using a single APD. By employing an SiPM array as a detector, and with DMD-based beam steering for the transmitter and FOV steering for the receiver, a lidar image is formed in a solid-state manner which use components having a high Technology Readiness Level (TRL), while eliminating the MEMS-resonant mirror from the system. The aforementioned MEMS-resonant mirror and DMD lidar architecture is leveraged for use in a lidar system by employing a 2-dimensional SiPM in lieu of a single APD detector for the receiver. Transmitter optics, a pulse laser and a DMD are used to provide flood illumination over several degrees, which is matched to the FOV of the 2-D SiPM ToF detector array. The illumination areas are sequentially illuminated by the transmitter DMD and the receiver FOV is synchronously scanned. In this manner, the relatively narrow FOV of the SiPM array was overcome by steering the FOV by use of the receiver DMD. In the transmitter, the illumination angle is matched to that of the detector, which is several degrees. Therefore, compared to the conventional flood illumination that illuminates the entire FOV at once, the scanning lidar shown in this reference allows the illumination on the FOV to decrease from tens of degrees to several degrees. Consequently, it increases the power density of the transmitted laser pulses and increases the number of returning photons. By this increased number of returning photons, the maximum detection range is increased.

### SUMMARY

In one aspect, the subject matter described herein provides a wide field-of-view (FOV) MEMS-based all-solid-state lidar system that employs high technology readiness level (TRL) components. By use of a highly efficient and repeatable lidar image steering technique, the system FOV can be well controlled and pointed to the specific target location.

In another aspect, the lidar system described herein employs an image steering method that achieves a time-multiplexing field of view (FOV) expansion by employing a Digital Micromirror Device (DMD) as a programmable blazed grating and a 2-dimensional lidar sensor array as a detector. In one illustrative embodiment that employs a 905 nm nanosecond pulsed laser, the lidar system demonstrates a seven times improvement in the FOV without sacrificing the angular resolution of the lidar images. A lidar image crosstalk test and an advanced image stitching process reveal that this illustrative embodiment of the lidar system is capable of horizontally expanding the lidar detection area to a 44° full field of view in real-time.

In one particular embodiment, a LIDAR system is provided for detecting one or more objects in an extended region. The Lidar system includes a laser source configured to generate laser light pulses, a first DMD, a second DMD and a two-dimensional (2D) sensor array. The first DMD is configured to receive the laser light pulses and diffractively steer the laser light pulses to sequentially illuminate different sub-regions within the extended region. The second DMD is configured to receive reflected light pulses from the different sub-regions in a sequential manner as each of the different sub-regions is illuminated by the laser light pulses. The 2D sensor array configured to receive reflected light pulses from the second DMD and form an image of the different sub-regions as the reflected light pulses from each of the different sub-regions is sequentially received from the second DMD.

### BRIEF DESCRIPTION OF THE DRAWINGS

FIG. 1(a) is a schematic illustration of an example of a lidar optical system in accordance with the subject matter described herein; FIG. 1(b) shows the illumination pattern of the lidar system and an overlayed area of the 2D sensor array incorporated in the detector as the scanning sequence scans over multiple sub-FOVs; FIG. 1(c) is a photograph of the lidar system illustrating the geometry of the various components and FIG. 1(d) is a system control-flow diagram of the lidar system showing how the system field of view is steered into the seven diffraction orders in a sequential manner by the Tx-DMD and the RX-DMD.

FIG. 2 is a schematic block diagram of the illustrative lidar system shown in FIG. 1.

FIG. 3 is a timing diagram illustrating a trigger sequence that may be employed by the lidar system shown in FIG. 2.

FIG. 4(a) is a photograph of an illustrative lidar system in accordance with the subject matter described herein and FIG. 4(b) shows a table of specifications for this illustrative lidar system.

FIG. 5(a) shows dynamic diffractive lidar images of 7 diffraction order captured by an MPPC module and FIG. 5(b) shows a lidar image captured with a static state of the DMD mirrors.

FIG. 6(a) is a photograph of the test target and FIG. 6(b) shows the lidar angular resolution versus the diffraction order.

FIG. 7a shows the illumination pattern of a 905 nm pulsed laser captured by using an infrared sensitive camera for each of the diffraction orders, and FIG. 7b shows a test target position that represents the center of the sub-FOV, or field of view that is accommodated by each of the diffraction orders.

FIG. 8 shows the results of a lidar image crosstalk test.

FIG. 9 shows a camera image (top row) of the letter targets “L”, “I”, “D”, “A”, and, “R” and the corresponding MPPC lidar image (center row) and a time-of-flight maximum distance test from 1 m to 20 m (bottom row).

FIG. 10 is a plot of lidar steering angles as a function of DMD diffraction orders along with the sub-FOVs (shown in the vertical bars) based on the grating equation.

FIGS. 11(a)-11(c) illustrate an image stitching process in which 2 targets are located in front of the DMD-MPPC detector.

FIG. 12A is a schematic illustration showing details of an example DMD suitable for use in the present invention; and FIGS. 12B-12D show the DMD of FIG. 12A in various states of operation;

FIG. 13A shows an incoming beam of light incident on an array of mirrors of an actuatable mirror array generating a diffraction pattern having various orders; FIG. 13B shows a DMD having a beam of a beam diameter D greater than the DMD pitch size p; and FIG. 13C illustrates that, by tilting the mirrors of a mirror array such that the mirror normals form an angle Θₘᵢᵣᵣₒᵣ relative to the DMD normal angle, light can be selectively directed into a given order.

### DETAILED DESCRIPTION

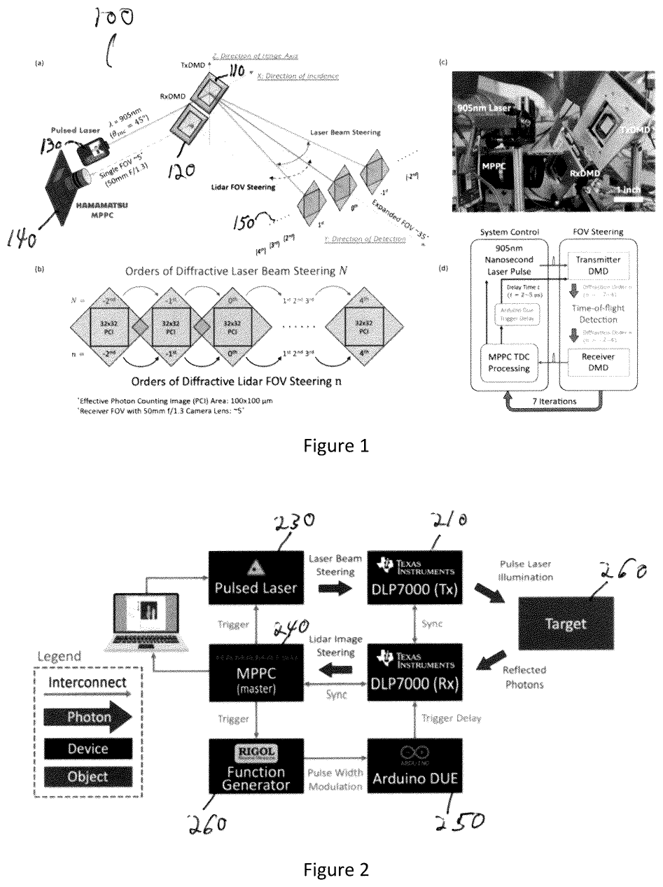

FIG. 1(a) is a schematic illustration of an example of a lidar optical system 100. Lidar optical system 100 includes a transmitter (Tx) digital micromirror device (DMD) 110, a receiver (Rx) DMD 120, a light source 130 and a detector 140 that includes a two-dimensional (2D) sensor array having the capability of time-of-flight (ToF) measurements. The lidar optical system detects objects located within a region defined by its field-of-view (FOV) 150.

In a conventional flash lidar system, the transmitter (Tx) illuminates the entire FOV that matches the FOV of the receiver (Rx) optics. As the FOV increases, the power density of the transmitted laser beam decreases. Also, the f-number of the receiver optics tends to decrease as the FOV increases. Consequently, the returning signal is further limited by the aperture of the optics. As the receiver FOV increases, the instantaneous FOV (iFOV) also increases, which leads to a decrease in resolution. Due to such trade-offs, flash lidar system are mainly employed to detect nearby objects. The lidar optical system depicted in FIG. 1(a) works around this trade-off by sequentially scanning sub-FOVs within the full FOV. This is accomplished by sequentially illuminating the sub-FOVs using the transmitter DMD 110 while the FOV of the receiver DMD 120 scans the sub-FOVs in a synchronous manner to the transmitter DMD 110. The sub-FOVs are matched to the two-dimensional sensor array of the detector 140 so that an image of each of the sub-FOVs can be formed by the two-dimensional sensor array.

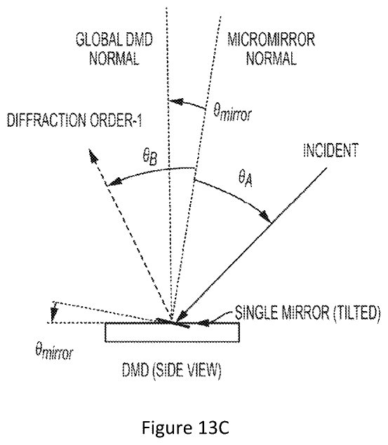

The flood illumination provided to the various sub-FOVs by the transmitter DMD 110 and the sequential scanning of the sub-FOVs by the receiver DMD 120 in a synchronous manner to the transmitter DMD 110 employ a discrete DMD beam steering process that has been described in U.S. Pat. No. 11,635,614, which is hereby incorporated by reference in its entirety. This DMD steering process will be described by reference to FIGS. 12 and 13.

FIG. 12A is a schematic illustration showing details of an example DMD suitable for use in the present invention. For example, the DMD may comprise a 608×684 array (horizontal by vertical) of micromirrors, such as part DLP3000 available from Texas Instruments of Dallas, Tex. As shown in FIG. 12A, the micromirrors may be positioned in a diamond configuration with a pitch of 10.8 μm. In DMD 210, the micromirrors flip between an ON state (shown in FIG. 12B as a viewed along section line 2-2 in FIG. 12) and OFF state (shown in FIG. 2D as a viewed along section line 2-2 in FIG. 12A) by rotating+/−12° about an axis defined relative to a normal of a micromirror. FIG. 12C shows the DMD in a non-operational “parked” state.

In some embodiments, the DMD mirrors move continuously between the ON and OFF states with a typical transition time on the order of a few micro seconds. A transitional state of the DMD is utilized by projecting a short pulsed laser whose pulse duration is much shorter than the transition time of the mirrors. With the short pulsed laser, the micromirror movement can be “frozen” at a plurality of angles between the stationary ON and OFF states. Thus, it is feasible to form a programmable blazed diffraction grating to discretely steer a collimated beam (e.g., a laser beam). It is to be appreciated that in some cases more than one pulse of light may be incident on a DMD during a single transition between the ON and OFF states, the pulsed occurring at different times than one another. The multiple pulses have the effect of freezing the mirrors at multiple blaze angles at the different times during a single transition.

As shown in FIG. 13A, an incoming beam of light incident on an array of mirrors as shown in FIG. 12A will generate a diffraction pattern having various orders (e.g., −4, −3, −2, −1, 0, 1, 2, 3, 4).

As shown in FIG. 13B, for the DMD to effectively diffract light in a beam, it is typically desirable that the beam diameter be at least equal to two-times the pitch size p. Ie some embodiments, it is preferable that the beam diameter be at least three times the pitch size p, A group of mirrors positioned to direct a given beam are referred to herein as a pixel of the DMD.

The diffraction orders generated by projecting a beam onto an array of micromirrors in a manner as described above are defined by the following diffraction grating equation (1):

p sin θₘ=2mλ (1)

where θₘ is the angle from the zeroth order to the m^{th} order shown in FIG. 13A, p is the mirror pitch (width), λ is the wavelength alight in the beam, and the factor of 2 is due to the diamond micromirror orientation of the illustrated embodiment, Eqn. (1) as set forth above is for instances where the angle of incidence of incoming light is normal to the mirror array surfaces. Mirror arrays according to aspects of the present invention may be operated with light projected at any angle with appropriate mathematical consideration.
As shown in FIG. 13C, by tilting the mirrors such that the mirror normal forms an angle θₘᵢᵣᵣₒᵣ relative to the DMD normal angle, light can be selectively directed into a given order (e.g., order −1). For example, to efficiently direct light into order −1, the mirrors are angled such that θ_{A}=θ_{B}, In some diffractive embodiments, light is diffracted by the DMD into one of the specific diffraction orders with diffraction efficiencies close to 100% since the frozen state of the tilted DMD mirrors is equivalent to a blazed grating where the slope of the mirror is set to the blaze angle.

It will be appreciated that, although the illustrated embodiment has a diamond configuration, any suitable orientation may be used. Additionally, mirrors of any suitable shape may be used (e.g., square or rectangle). It will be appreciated that other mirror array shapes and orientations are governed by an equation similar to equation (1), but modified to account for the configuration of the mirror array.

The light source illuminating the DMD (e.g., light source 130 in FIG. 1) is adapted to provide the incident wavefront in pulses of light having a maximum duration, tₘₐₓ, to the DMD, where tₘₐₓ≤T, where T is the transitional time of the DMD mirror array, which is sometimes referred as a crossover time. The light source may be collimated or uncollimated, coherent or quasi-coherent, monochromatic or quasi-monochromatic. For example, the light source may be a laser with or without a collimating lens or an LED with or without a collimating lens. For example, T/tₘₐₓ may be equal to or greater than any of 50, 100, 250.

It will be appreciated that a plane wave of short duration (tₘₐₓ≤T) when projected onto DMD 210 is diffracted into one of the specific diffraction orders with relatively high diffraction efficiency since a short pulse of light duration causes the DMD mirrors to appear to be in frozen state in a particular state that is equivalent to a blazed grating where the slope of the mirror is set to the blaze angle. Typically, all mirrors in the array onto which the light is projected are controlled to be actuated to a same degree (i.e., they have the same blaze angle); however, in some embodiments, only a subset of mirrors (e.g., at least 90% or at least 80% or at least 50%, due to the sequential reset of DMD mirror regions.

Additional details concerning the DMD steering process may be found in U.S. Pat. No. 11,635,614.

In summary, when the mirrors of the DMD transition between the on- and off-states, the tilt angle of the mirrors changes from −12 to +12 degrees. The transitional period is typically several microseconds, which is referred to as the crossover time. Thus, if a nanosecond (ns) laser pulse illuminates the DMD mirror array during the dynamic tilt motion, the movement of the mirrors is effectively “frozen” due to the order of magnitude difference in time scale of the crossover time (us) and pulse length (ns). Thus, the illumination pulse is timed to be received by the DMD while the micromirrors are in transition so that the DMD satisfies the blazed condition. The number of diffraction orders supported by this beam steering method depends on the pixel period, the wavelength, the angle of incidence of the laser with respect to the surface normal of DMD device, and maximum tilt angle of the DMD micromirrors. For example, at a wavelength of 532 nm, a pixel period of 5.4 um, with a normal incidence of the laser, and a maximum tilt angle of ±12 degrees, the number of diffraction orders is about 10, thus the number of sub-FOVs is 10. For a longer wavelength of 905 nm with the same DMD structure, the number of diffraction orders is decreased to 7.

Referring again to FIG. 1, for purposes of illustration, in one embodiment the light source 130 will be described with reference to a 905 nm pulsed laser diode such as the LS9-220-8-S10-00, which is available from Laser Components Inc. In this illustrative embodiment the emitted pulses are directed towards the Tx-DMD 110 (e.g., model DLP7000 with a D4100EVM) with a 45 degree angle of incidence, and are diffractively steered in the horizontal direction (i.e., the x-direction). Returning photons from the targets within the detection region are then collected by the Rx-DMD 130 (model DLP7000 with a D4100EVM). The light is then directed from the Rx-DMD to the detector 140 via optional optics (e.g., F/1.3, f=50 mm optics). In the particular embodiment that is illustrated, with 32×32 channels having a 0.1 mm pixel period, the illustrative Rx sub-FOV is 5 degrees FOV at a 45 degrees angle of incidence.

The detector 140 in FIG. 1a may be any suitable two-dimensional (2D) sensor array having the capability of time-of-flight (ToF) measurements. Examples of suitable 2D sensor arrays include single photon sensor arrays, avalanche photodiode (APD) arrays and Si single photon avalanche diode (SPAD) arrays. For purposes of illustration, in one embodiment the detector 140 will be described as a Multi-Pixel Photon Counter (MPPC) module, which is an example of a single photon sensor array that includes a time-of-flight module (e.g., model S15013-0125NP-01, Hamamatsu Photonics).

In operation, light from the laser source is first directed to the Tx-DMD while the mirrors of the Tx-DMD are in transition between their on and off states and angled at a blaze angle that directs the light to a first selected diffraction order, which corresponds to one of the sub-FOVs. In the example shown in FIG. 1 the blaze angle is chosen to direct the light to the −2^{nd} order. In this way the light from the laser source floods the sub-FOV corresponding to −2^{nd} order. The light from the sub-FOV is reflected towards the Rx-DMD at the same diffraction order. That is, the Rx-DMD is triggered so that its mirrors are in transition between their on and off states and set to the same blaze angle as the Tx-DMD when it receives the light from the selected sub-FOV. The Rx-DMD then directs the light to the detector. This sequence in which a selected sub-FOV at a selected order is flooded with light from the Tx-DMD and then directed to the detector by the Rx-DMD may be repeated for additional sub-FOVs until the entire desired full FOV has been detected. That is, multiple sub-FOVs may be sequentially scanned to detect the full FOV.

FIG. 1(b) shows the surface of the 2D sensor array incorporated in the detector as the scanning sequence scans over multiple sub-FOVs. In this example the sub-FOVs are scanned from −2^{nd} order to +4^{th} order. Superimposed on the 2D sensor array is the image (in this case the effective photon counting image) formed by the sub-FOVs on the 2D sensor array. In this example the sub-FOV that is received is about 5×5 degrees and thus the steering of the light to scan the sub-FOVs over the 7 diffractions orders (from −2^{nd} order to +4^{th} order), expands the system FOV by a factor of 7 over the original FOV, to a 35° full field of view.

FIG. 1(c) is a photograph of the lidar system illustrating the geometry of the various components. FIG. 1(d) is a system control-flow diagram of the Lidar system showing how the system field of view is steered into the seven diffraction orders in a sequential manner by the Tx-DMD and the RX-DMD.

It should be noted that in some cases the sequential manner in which the illumination is steered to the different sub-FOVs by the Tx-DMD, then directed to the Rx-DMD and finally imaged by the 2D sensor array of the detector may be determined in any desired order. For instance, in FIG. 1b the sub-FOVs are scanned in a numerical order based on the diffractive order at which the sub-FOVs are located (e.g., from the −2^{nd} order to the +4^{th} order in FIG. 1B). However, more generally, the sub-FOVs may be illuminated and imaged in any other suitable sequence including, for example, a randomly selected sequence.

FIG. 2 is a schematic block diagram of the illustrative lidar system shown in FIG. 1 showing the paths of the light (thick arrows) and the electrical signals (thin arrows) that control operation of the system. In this particular example the light source is a pulsed laser 230 that directs light pulses onto a DLP 210 that serves as the Tx-DMD. The pulses are then directed onto a target 260 and collected by a DLP 220 that serves as the Rx-DMD, which in turn directs the pulses to an MPPC that serves as the light detector 240. An Arduino DUE microcontroller 250 serves as a processor for controlling the DMDs and, as explained below, a function generator 260 is used to cause the Arduino DUE microcontroller 250 to trigger the DMDs via a trigger signal from the MPPC.

In the scanning sequence depicted by the arrows in FIG. 2, the MPPC 240 serves as a master and triggers the pulsed laser 230 to begin the time-of-flight measurement. The first pulse is directed towards the Tx-DMD 210 at the −2^{nd} diffraction order, which illuminates object(s) and the object reflects the pulse towards the Rx-DMD at the same diffraction order. The MPPC 240 captures this pulse and generates a single frame of the −2^{nd} order lidar image. Once the sub-FOV of the −2^{nd} order is scanned, in the following cycle, timing between the mirror movement and the pulsed laser is adjusted so that Tx-DMD and Rx-DMD diffracts/receives light to/from the −1^{st} order. The delay timing is adjusted by the Arduino microcontroller 250 that is employed between the MPPC 240 (serving as the master trigger) and the Tx- and Rx-DMDs. After the MPPC 240 completes processing the time-to-digital conversion of the −1^{st} order lidar image, it sends a trigger to the Arduino to begin the next detection cycle, generating a delay time for the 0^{th} order lidar steering, and so on and so on for the different orders to be scanned. By repeating this workflow, the lidar system can sequentially capture lidar images of targets located within a region of interest (ROI) at seven different diffraction orders.

In the workflow depicted in FIG. 2, the MPPC module 240, serving as the master, triggers the pulsed laser 230 and the Arduino DUE 250 to control the time delay to the Tx- and Rx-DMDs. The function generator 260, which is between the MPPC module 24 and the Arduino DUE 250, bridges the trigger signal while stretching the duration of the trigger signal (e.g., from 100 ns to 10 μs) so that the microcontroller recognizes the trigger from the MPPC module 240.

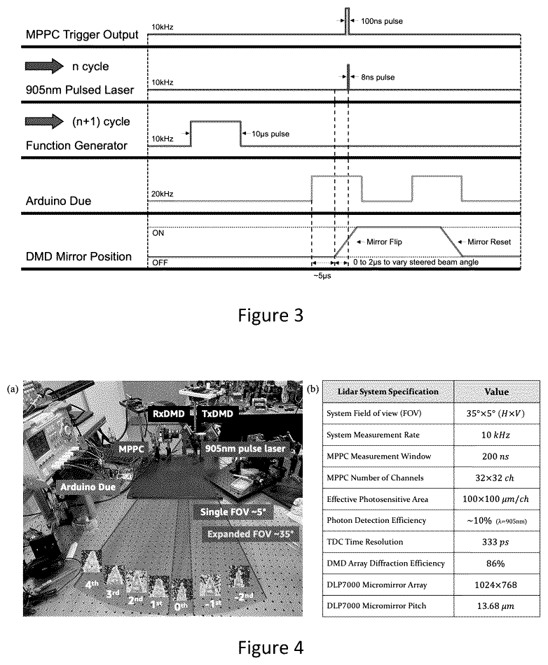

Thus, the MPPC module 240 provides a master clock signal to the pulsed laser 230 and the Tx- and Rx-DMDs 210 and 220 while adjusting the delay time between the pulsed laser 230 and the Tx- and Rx-DMDs 210 and 220. The MPPC module 240 triggers out a master signal at, for example, 10 kHz with a 100 ns width. The MPPC module 240 starts capturing a lidar image and a trigger is sent to the pulsed laser 230 to trigger a short pulse e.g., an 8 ns pulse. In order to select particular diffraction orders for setting the Tx- and Rx-DMD blaze angles, the Arduino DUE delays the trigger to the pulsed laser 230 with respect to the trigger to the DMDs. However, the DMDs have an additional, global time delay. After the DMDs are triggered their mirrors start transitioning between the on and off states. Between the timing of the trigger in and the start of the mirror transitions, a global delay exists (about 5 μs for the particular DMDs chosen in this example). Due to the global delay of the DMDs, it is not possible to adopt a trigger sequence in which the pulsed laser is triggered before the DMD. Rather, the trigger sequence may be rearranged as shown in the timing diagram of FIG. 3.

Once the signal from the MPPC module 240 triggers the Arduino Due 250 via the function generator 260, the function generator 260 triggers the DMDs at the next cycle. For example, if the laser pulse is at the n^{th} cycle, the trigger from the function generator is for the (n+1)^{th} cycle. The pulse from the function generator 260 triggers the Arduino Due 250 to generate two reset signals within a single cycle of the ToF measurement. The first pulse from the Arduino Due 250 changes the state of all the mirrors of the DMDs, and the second pulse is used to reset the DMDs. In each cycle, the DMDs will be reset to their original positions and wait for the next trigger from the MPPC module 240.

The technique in which the prior trigger from the MPPC module 240 is used to control the synchronization of the laser pulses and the DMD mirror transitions accommodates the global delay of DMD. To select diffraction orders, further fine tuning of the timing is required. The Arduino Due can be programmed with the no-operation command (NOP) to finely control the timing of the micromirror transitions. One NOP in the Arduino Due 250 corresponds to one clock cycle, 12.5 ns (1/80 MHz), which is sufficiently short compared to the time window (˜50 ns) need to maintain high diffraction efficiency.

It should be noted that the particular workflow illustrated in FIG. 2 and the associated timing diagram shown in FIG. 3 are presented for illustrative purposes only. More generally, different workflows, using the same or different components, may be used to implement the beam steering process employed by the lidar system described herein.

### Illustrative Results

FIG. 4(a) is a photograph of an illustrative lidar system in accordance with the subject matter described herein, which employs an MPPC module with a 905 nm pulsed laser diode and two DMDs that are synchronized with one another. FIG. 4(b) shows a table of specifications for this illustrative lidar system. The lidar system underwent a series of tests, including for diffractive image quality, angular and distance resolution, cross-talk, and maximum measurable distance, the results of which are presented below.

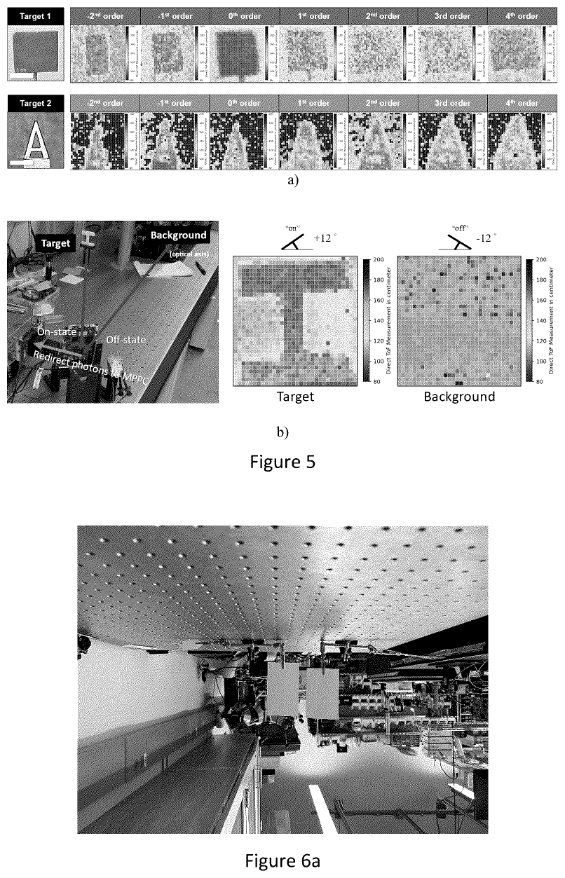

As shown in FIG. 5(a), two different targets were employed. Target 1 is a square cardboard target, and Target 2 is represented by the letter “A”. The targets were placed 100 cm away from the lidar detector. The Tx-DMD and the Rx-DMD are arranged to transmit/receive single diffraction orders, from −2^{nd} and +4^{th}. The target 1 and 2 were placed at the center sub-FOV, and lidar images were captured by the system. The colors in the ToF lidar images represent the depth information of the target which is half of the light travel distance from transmitter to receiver (note that in FIG. 5a and the figures that follow, original color images are represented in grayscale only). For instance, if the object were to appear more red in the lidar image, it is closer to the detector than an object that appears more blue. The lidar image is provided as a direct output from a single frame of the MPPC ToF module, with no image processing employed. For the purpose of comparison, lidar images captured via a static state of the DMD (at on-state and off-state) is shown in FIG. 5b. For lidar images at different sub-FOVs one may notice that the horizontal magnification changes as the beam is steered. Also, the signal is stronger at the 0^{th} order compared to the other orders. Those artifacts are due to a variation of the horizontal magnification upon diffraction and reflection from the DMD cover glass.

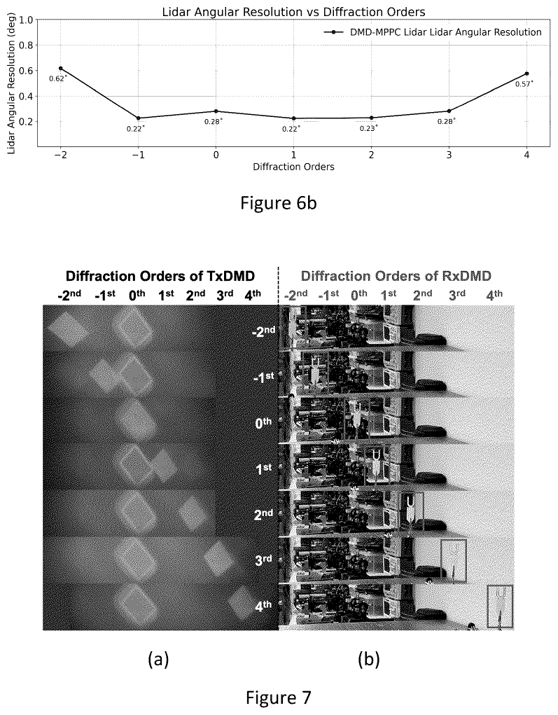

The angular resolution test was performed by using 2 targets placed at 100 cm, with the smallest spacing between them being the spacing that the lidar system can still resolve. Table 1 shows the angular resolution of DMD-MPPC lidar system. The smallest angular resolution that the system can achieve is 0.22 degrees, which happens at −1^{st} and +1^{st} orders of diffraction. This corresponds to 2 times of iFOV of system or 0.11 degrees. FIG. 6(a) is a photograph of the test target and FIG. 6(b) shows the lidar angular resolution versus the diffraction order. As FIG. 6(b) shows, when the slit is intentionally aligned to the MPPS pixels, the slit width of 0.11 degrees that corresponds to iFOV is resolvable.

TABLE 1
Angular Resolution Testing Result

| Diffraction | Targets | Targets | Angular |
|---|---|---|---|
| Orders | Location (cm) | Spacing (cm) | Separation (deg) |
| −2 | 102.1 | 1.1 | 0.617 |
| −1 | 102.8 | 0.4 | 0.223 |
| 0 | 103.2 | 0.5 | 0.278 |
| 1 | 103.4 | 0.4 | 0.222 |
| 2 | 101.6 | 0.4 | 0.226 |
| 3 | 102.8 | 0.5 | 0.279 |
| 4 | 99.8 | 1.0 | 0.574 |

In the Tx-DMD, the diffractive beam steering process suffers from an energy spill over to adjacent diffraction orders due to the fill factor, which is about 90%. In a realistic lidar imaging scenario, objects are placed across the different sub-FOVs. With the energy spill-over, the Tx-DMD illuminates not only the object, but also objects that reside in the adjacent sub-FOVs even though the spilled over power is substantially reduced. The same situation occurs with the Rx-DMD. The object of interest returns a signal with high efficiency if the object resides in the sub-FOV that Rx-DMD is observing. If the area of illumination of the Tx-DMD spans beyond the sub-FOV of interest, the Rx-DMD receives the signal from the adjacent sub-FOVs.

FIG. 7a shows the illumination pattern of a 905 nm pulsed laser captured by using an infrared sensitive camera for each of the diffraction orders, and FIG. 7b shows a test target position that represents the center of the sub-FOV in which a U-shaped object is detected. The diamond shape 905 nm laser beam spots are formed by illuminating the laser pulse onto the Tx-DMD with the 45° micromirror hinge-axis-of-rotation perpendicular to the table. An infrared camera was used to sequentially capture the 7 diffraction orders of laser patterns. In FIG. 7a, we observe that the illumination area is sequentially steered from the −2^{nd} order to +4^{th} order, from the top row to the bottom row. A faint diamond pattern appears other than the order of interest that shows spill over of the diffracted illumination beam to neighboring orders. Also, a cover glass reflection, about 30% exists at the 0^{th} order regardless of the order that is being steered to by the Tx-DMD. The coverglass reflection is due to the anti-reflection coating designed for the visible wavelength range. At these wavelengths the coverglass has a very small reflection. However, at the infrared wavelength of 905 nm, about 20% of the light is specularly reflected towards the 0^{th} diffraction order. As small reflections of the cover glass at visible wavelengths show, a cover glass which is optimized for the wavelength can eliminate the specular reflection at 905 nm wavelength.

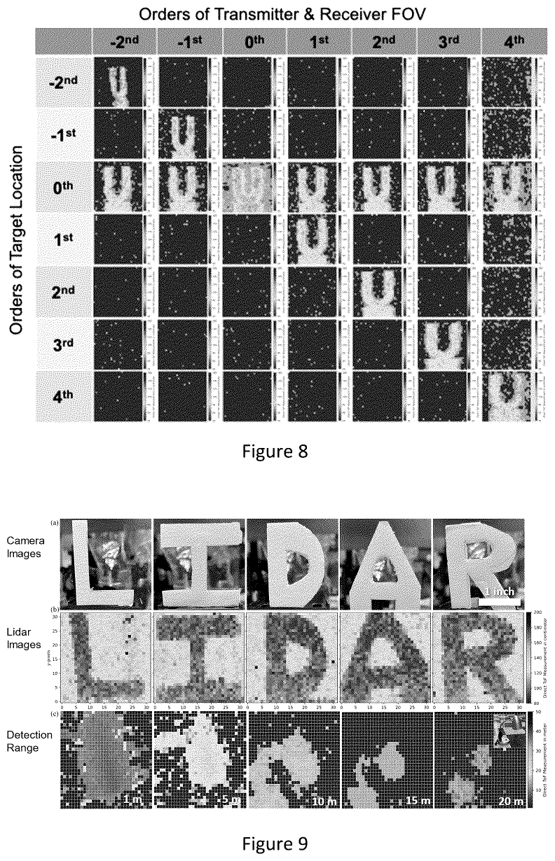

FIG. 8 shows the result of the lidar image crosstalk testing. The letter “U” was used as a target in this test. The horizontal axis is the diffraction orders of the transmitter and receiver FOVs while the vertical axis shows the different orders of the location at which the target is placed. At the diagonal of the matrix, an image is captured while the rest of the image contains no image of the “U” despite the target residing there. The result shows that the lidar images are accurately captured by the MPPC with a high signal-to-noise ratio (SNR) by steering the flood illumination so that it is limited within the sub-FOV by the Tx-DMD while steering the FOV of the Rx-DMD in a synchronous manner. One may see that on the 4^{th} column of the Tx and Rx FOV, the SNR is slightly lower than the rest of the images since the system is close to the wall on the right side, which reflected a few more photons back to the MPPC. On the 0^{th} row, the target was placed at the normal incidence of the DMD where Tx and the Rx FOV were looking, and it shows that the system imaged all 7 diffraction orders with a relatively lower SNR on the 0^{th} orders of the DMD. As mentioned previously, the reflection from the cover glass of the DMD at a wavelength of 905 nm is high, about 20%, since the anti-reflective (AR) thin film coating of the cover glass of the DMD used is designed for visible wavelengths. The artifact appearing at the 3r d row from the top can be mitigated by an AR coating designed for infrared and/or a wedge window can be attached to the DMD window so that specular reflection from the cover glass is re-directed to a point between the sub FOVs. The cross-talk testing shows that even though the cover glass reflection is present, all the remaining results indicate that the lidar system does not have significant crosstalk among different orders.

FIG. 9 shows a camera image (top row) of the letter targets “L”, “I”, “D”, “A”, and, “R” and the corresponding MPPC lidar image (center row). The letter targets were placed 100 cm away from the lidar receiver and captured by the MPPC array. FIG. 9 (bottom row) shows a time-of-flight maximum distance test from 1 m to 20 m. With the clear contour of the targets showing in the lidar images, the MPPC provides a powerful time-of-flight detection capability with an angular resolution around 0.11 degrees. A real-time 2-dimensional silicon photomultiplier saves significant time to generate the lidar images relative to a raster scanning MEMS lidar system.

To test the detectable range of the MPPC lidar system, the maximum distance test was performed with a desk lamp as a target. A blue background in the color lidar images indicates that there is nothing but the one target in the test field. When the target was located 10 meters away from the system, it was still well captured by the MPPC with the correct depth information. Due to space limitations, however, the maximum range in this test is 20 meters. In fact, the MPPC is capable of detecting the target located up to a distance of meters with use of a lower threshold voltage and a longer focal length camera lens.

### Discussion

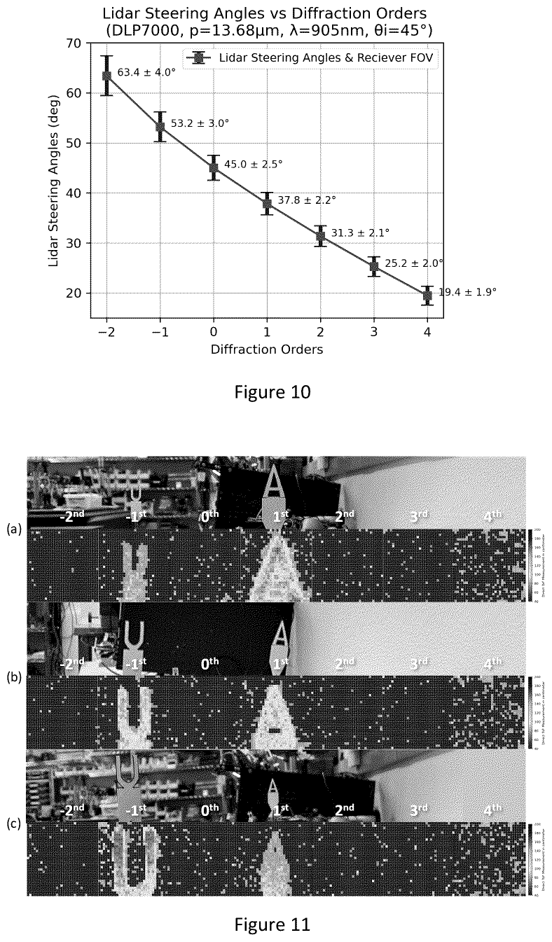

FIGS. 5 and 8 show that the horizontal extent of the image varies at each of the sub-FOVs. This is due to the change of the horizontal magnification upon diffraction. FIG. 10 is a plot of lidar steering angles as a function of DMD diffraction orders along with the sub-FOVs (shown in the vertical bars) based on the grating equation. The plot shows the nonlinearity change of the lidar system FOV. The MPPC with a 50 mm f/1.3 camera lens has a sub-FOV around 5 degrees. As the diffraction order changes from +4st order to −2^{nd} order, the system FOV expands from 3.8 degrees to 8 degrees. With respect to the sub-FOV at 0^{th} order, the sub-FOV at −2^{nd} order is 60% wider. In contrast, the sub-FOV at +4^{th} order is 24%. As Table 1 shows, the f=50 mm lens with the 32×32 pixel 100 μm MPPC has a resolution (or iFOV) calculated as 0.11°, which meets the required system resolving power for automotive lidar applications. Since the iFOV changes at each of the sub-FOVs due to diffraction effects, the variation of the iFOV over the sub-FOVs can be equalized either by decreasing the angle of incidence to the DMD (the illustrative embodiment shown above has an angle of incidence of 45 degrees) and/or employing a fast varifocal lens such as a liquid lens to adjust the focal length while the Tx- and Rx-DMDs steer the flood illumination and the receiver FOV. Gaps between each of the orders may still be noticed, which also may be solved by use of a shorter focal length lens for the receiver, while the Tx-DMD illuminates the entire sub-FOVs.

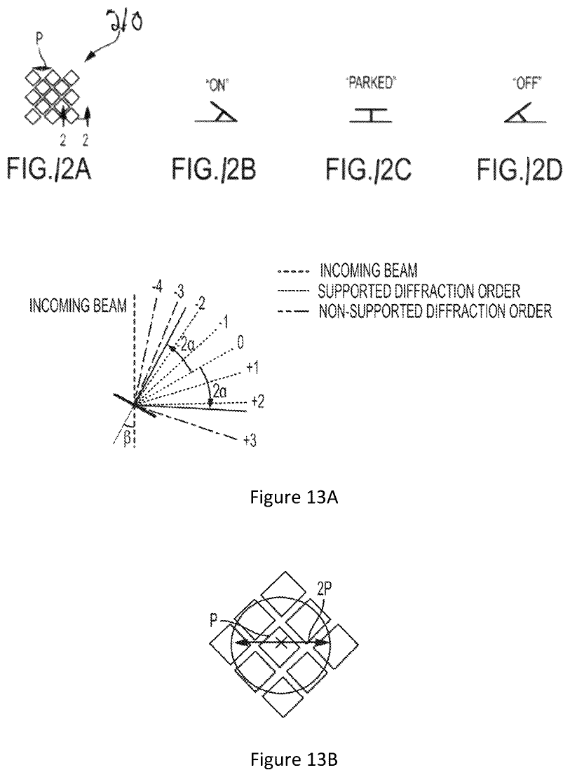

To acquire a wide single frame of the MPPC lidar image with correct depth information, an image stitching process may be used in conjunction with the diffractive image steering method described herein. FIGS. 11(a)-11(c) illustrate the image stitching process in which 2 targets are located in front of the DMD-MPPC detector. In FIG. 11(a), when the letter A is closer than the letter U, it appears redder in the color lidar image compared to the more distant letter U, which appears greener in the color lidar image. In FIG. 11(b), the letter U is closer than the letter A and the colors would be reversed in the color lidar image. If those 2 targets are at the same distance from the front of the detector, as shown in FIG. 11(c), the colors of the targets in the lidar image would be more similar to one another. The image stitching process shows the capability of making a real-time, wide FOV lidar image using the lidar system described herein. This image stitching process can be simplified and automated by programming the FPGA time-to-digital converter pipeline, as well as by applying a well post-processing lidar image algorithm.

Ultimately, a lidar system for ADAS applications needs a pixel count of 1M or higher with a high frame rate of 30 fps. With a 32×32 pixel MPPX and 7 sub-FOVs, one embodiment of the solid-state lidar system described herein supports 32×32×7=7 k pixels and operates with a frame rate of 120 fps with a 1 k fps DMD. In alternative embodiments a detector with a higher pixel count and/or faster DMDs may be employed to fill the gap so as to meet ADAS requirements. For instance, a recently available 0.1M pixel CMOS ToF sensor may be employed. Since the DMDs are not detector specific, with a moderate number of sub-FOV multiplexing of 10, a 1M pixel lidar system is feasible. Detectors with smaller pixel counts may require additional FOV multiplexing and an even higher frame rate. Currently, DMDs operate with 100 fps and approach 42 k fps. By employing an additional but slower steering mechanism, such as MEMS Phase Light Modulators, for example, a solid-state implementation of the lidar system may still be achieved.

In summary, a lidar system providing diffractive expansion of the field of view of a time-of-flight (ToF) lidar receiver has been experimentally demonstrated and verified. The limited FOV of the 2-dimensional array of a Multi Pixel Photon Counter is enhanced by a factor of seven without sacrificing the resolution of the ToF lidar image. The diffractive FOV expansion is enabled by nanosecond pulsed illumination of the DMDs while the DMDs' micromirrors are in motion. The use of nanosecond laser illumination turns the DMD into an FOV expander.

The maximum distance testing and the lidar images crosstalk testing of all the diffraction orders have been used to verify the time-multiplexing technique described herein that involves configuring the DMDs as diffraction blazed gratings. With the further use of image stitching, the FOV of the lidar image provided by the MPPC module can theoretically be expanded to a 35° full FOV in real-time without any mechanical moving elements being used, which opens a pathway to advanced lidar applications.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers

What is claimed is:

1. A LIDAR system for detecting one or more objects in an extended region, comprising:
a laser source configured to generate laser light pulses;
a first DMD configured to receive the laser light pulses and diffractively steer the laser light pulses to sequentially illuminate different sub-regions within the extended region;
a second DMD configured to receive reflected light pulses from the different sub-regions in a sequential manner as each of the different sub-regions is illuminated by the laser light pulses; and
a two-dimensional (2D) sensor array configured to receive reflected light pulses from the second DMD and form an image of the different sub-regions as the reflected light pulses from each of the different sub-regions is sequentially received from the second DMD.

2. The LIDAR system of claim 1 wherein the first and second DMDs each include a plurality of micromirrors each having a first and second state of operation and the laser light pulses have a duration less than a transition time of the micromirrors between the first and second states.

3. The LIDAR system of claim 2 wherein, while the micromirrors of the first DMD are transitioning between the first and states, the first DMD acts as a blazed grating that selectively diffracts a laser light pulse received from the laser source to a given diffraction order so that the laser light pulse illuminates a given one of the sub-regions within the extended region.

4. The LIDAR system of claim 3 wherein the second DMD is configured so that transitions of the micromirrors of the second DMD are synchronized with the transitions of the micromirrors in the first DMD so that the second DMD acts as a blazed grating that receives the laser light pulse at the given diffraction order.

5. The LIDAR system of claim 1 wherein the 2D sensor array includes a time-of-flight (ToF) measurement capability.

6. The LIDAR system of claim 1 wherein the 2D sensor array is selected from the group including a single photon sensor array, an avalanche photodiode (APD) array and a Si single photon avalanche diode (SPAD) array.

7. The LIDAR system of claim 1 wherein the 2D sensor array is a Multi-Pixel Photon Counter (MPPC).

8. The LIDAR system of claim 1 wherein the sequential manner is a randomly selected sequence of the sub-regions.

9. The LIDAR system of claim 1 wherein the sequential manner is based on a diffraction order with which the different sub-regions are respectively associated.

10. A method for detecting one or more objects in an extended region, comprising:
(a) diffractively steering a first light pulse to provide flood illumination onto a selected subregion within the extended region using a first programmable blazed grating that is set at a prescribed blaze angle, the first light pulse being diffractively steered to a first selected diffractive order at which the selected subregion is located;
(b) receiving a first reflected light pulse from the selected subregion using a second programmable blazed grating that is set to the prescribed blaze angle, the first reflected light pulse being received at the first selected diffractive order;
(c) directing the first reflected light pulse from the second programmable blazed grating to a two-dimensional sensor array that images the selected subregion; and
(d) repeating steps (a)-(c) for a second selected subregion within the extended region by diffractively steering a second light pulse to a second selected order at which the second subregion is located and receiving a second reflected light pulse at the second selected diffractive order.

11. The method of claim 10 wherein the first and second programmable blazed gratings are first and second DMDs, respectively.

12. The method of claim 11 wherein the first and second DMDs each include a plurality of micromirrors each having a first and second state of operation and the first and second light pulses having a duration less than a transition time of the micromirrors between the first and second states.

13. The method of claim 12 wherein the first light pulse is diffractively steered while the micromirrors of the first DMD are transitioning between the first and states such that the first DMD acts as a blazed grating that is set to the prescribed blaze angle.

14. The method of claim 13 wherein the first reflected light pulse is received from the second DMD while the micromirrors of the second DMD are transitioning between the first and states such that the second DMD acts as a blazed grating that is set to the prescribed blaze angle.
